(19) United States
(12) Patent Application Publication
(10) Pub. No.: US 2015/0254796 A1
(43) Pub. Date: Sep. 10, 2015

(54) COFICE

(71) Applicant: MAX REZA FOROUDI, Rancho Cordova, CA (US)

(72) Inventor: MAX REZA FOROUDI, Rancho Cordova, CA (US)

(21) Appl. No.: 14/315,468

(22) Filed: Jun. 26, 2014

Related U.S. Application Data
(60) Provisional application No. 61/947,428, filed on Mar. 4, 2014.

(51) Int. Cl. G06Q 90/00

(52) U.S. Cl. CPC G06Q 90/00

(57) ABSTRACT

A method and system of doing business in which, services provided to patrons in same place and under one name and at the same time includes:

(I) All kind of edibles, beverages and refreshments like drinks (cold and hot), foods and snacks (cold and hot) that normally and typically are served in coffee shops and Restaurants (fast food or regular) and,

(II) All kind of PRINT industry and electronic communication services like PRINT, COPY, SCAN, FAX and EMAIL. Said business to equip and mobilize with computer base or none-computer base Apparatus, Tools and devices to provide immediate access to make “Copy, Print, Fax, Scan and Email” along with serving foods and refreshments and drinks.

The present invention relates to importance and necessity of ability to exchange hard copy (paper) and/or computer base or not-computer base electronic files and documents, and having immediate access to documents that are needed to be signed or hand over while people do business or other social activities out of office or home.

### This none-provisional patent is continuation and claims all rights and benefits of provisional patent filed on Mar. 04, 2014 with confirmation number 61947428 by the name of “Office on the Go”.

### SUMMARY, FIELD, BACKGROUND, DISCLOSURE AND BRIEF DESCRIPTION OF THE INVENTION

As computer science and internet grows, in today's world coffee shops and restaurants (fast food or regular) have become centers to exercise social activities like: business meeting, study lessons, research, classrooms and many other activities. While people patron these centers (coffee shops and restaurants), necessity to PRINT, COPY, FAX or SCAN and EMAIL a document is becoming more and more distinguishable and imperative. Places like COFEE SHOPS, FAST FOODS, and RESTURANTS nowadays are like “Personal Office in Public Places” with lacking an important piece (necessity) which is imperative in today's world.

My invention is the idea of “business method” by combining two businesses together, these two businesses are food industry and print industry, ”, a place that people have their food, refreshment or “COFFEE” and do “OFFICE” activity, a “business method” that is the claim and purpose of this invention and I name it “COFICE”.

This invention claim at least two styles (approaches) to establish (start) and run this method of business (cofice):

(A) Starting from scratch, meaning establishing and starting new business place (shop, store and etcetera) that conduct both businesses in the same (one) location. Said business provides (serves) cold and/or hot foods and snacks like sandwiches, cookies, candies, chips, fruits(dried or fresh) and all other kinds of edibles and drinkables that normally and typically coffee shops and restaurants (fast food or regular) serve, and in the meanwhile patrons of such a business are able to make copy, fax, print, scan and email documents, files, pictures and all/any other services are provided by stores and shops that solely provide these services (like FedEx-kinkos).

(B) Adding facilities and apparatus necessary to either mentioned industries' shops and stores (meaning food industry like Starbucks or print industry like FedEx-Kinkos) that already are active, to provide all said and meant services of this invention.

Approach (B) claim includes and means adding printing and electronic apparatus and machines and other facilities necessary, either computer base or none-computer base, (which can provide copy, fax, print, scan and email), to coffee shops and restaurants (fast food and regular) like but not limited to Starbucks, Panera Bread, Peet's Coffee and Tee's, Tim Horton's, Tully's Coffee, McDonalds, and all other similar places. (Either chain or single, private owned or corporate or government owned). This means such a coffee shops or restaurants, after adding mentioned apparatus and facilities are also able to provide copy, fax, print, scan and email services and all other services which typically and normally are provided by stores like FedEx-Kinkos.

Approach (B) claim also includes and means adding facilities needed (apparatus, machines and etcetera) to provide and serve food, refreshments and snacks and all kind of edibles and beverages, to shops and places that already provide printing and communication services like FedEx- Kinkos and all other similar places. (Either chain or single, private owned or corporate or government owned). This means that such a store or place of business that already provides printing and communication services (like FedEx-Kinkos or similar), after adding facilities mentioned and meant in this invention are also able to serve cold and/or hot foods and snacks like sandwiches, cookies, candies, chips, fruits (dried or fresh) and all other kinds of edibles and drinkables that coffee shops and restaurants (fast food or regular) normally and typically serve. In the business places that are established and/or run by the means of this invention, patrons are able to exercise their social activities that people typically, normally and regularly do in coffee shops and restaurant (fast food or regular) and at the same time they have convenience of having immediate access to print or fax or scan and other communication and/or administrative services. So if in a business meeting there is a need of singing documents, it could be done right away, or if a tutor needs to copy hand out a pamphlet, she/he can do it on the spot and a lot of time and money and energy would be saved.

This invention includes all systems and methods that can be practiced from all suitable combinations of the various aspects disclosed, and all suitable combinations of the exemplary elements listed. Such combinations have particular advantages, including advantages not specifically recited herein.

The word “include” and “mean” are intended as open-ended terminology, with the same meaning as if the phrase “at least” were appended after each instance thereof. Each variation of this invention is limited only by the recited limitations of its respective claim, and equivalents thereof, without limitation by other terms not present in the claim. The above description does not include an exhaustive list of all aspects of the present invention. Indeed , the inventor contemplate that the invention includes all systems and methods that can be practiced from all suitable combinations of the various aspects summarized above as well as those disclosed in this description . Such combinations have particular advantages not specifically recited in this description of invention.

1. A method of business in which amenities and services provided under one name and one entity are combination of:
A- Coffee shops, fast foods and restaurants
B- All services available in print stores.
In this method of business customer(s) can have coffee and all other kind of refreshments and foods either edible or drinkable and in the same place and same business entity, have ability to use print stores facilities and services like but not limited to: Copy, Print, Fax, Scan, Email and etcetera, either computer or not-computer base and via internet if needed or without internet connection.

2. This method of business is called “COFICE”.

3. All existing coffee shops, fast foods, restaurants (which have the will and intention) can become “Cofice” by adding apparatus, devices and services necessary like but not limited to: Copy machine, Fax Machine, Printer, Scanner, Internet Wi-Fi and Router, computers and all other amenities in this category. These devices and systems could be those which are being used at the time being or will be added to the industry in future, like new devices and systems that created or invented in future. Adding services, apparatus and amenities can be selected to add individually (like just one or two or...) or all together, depend upon market condition, location and size of the business.

4. All existing PRINT stores which currently provide services like copy, fax, print, scan and email can become “Cofice” (if have the will and intention) in the same place by adding and providing services regularly provided by Coffee shops, Fast foods, restaurants or anything in this category. Adding services and apparatus could be selected individually (like just one or two or...) or all together, depend upon market condition, location and size of the business.
